(19) United States
(12) Patent Application Publication
(10) Pub. No.: US 2015/0235260 A1
(43) Pub. Date: Aug. 20, 2015

(54) FORECASTING ELECTRONIC EVENTS

(71) Applicant: LINKEDLN CORPORATION, Mountain View, CA (US)

(72) Inventors: Kai Wei, Belmont, CA (US); Roshan R. Sumbaly, Santa Clara, CA (US); Souvik Ghosh, San Jose, CA (US); Kancheng Cao, Bothell, WA (US)

(73) Assignee: LINKEDLN CORPORATION, Mountain View, CA (US)

(21) Appl. No.: 14/184,918

(22) Filed: Feb. 20, 2014

(51) Int. Cl. G06Q 30/02; G06Q 10/06

(52) U.S. Cl. CPC G06Q 30/0246; G06Q 10/067

(57) ABSTRACT

A system and methods are provided for forecasting the volume of future events that match specified attributes regarding type of event (e.g., serving of an advertisement impression, a page view, fraudulent activity), attributes of entities involved in the events (e.g., users, content items, system components), and/or other factors. A forecast query is received with one or more terms identifying target criteria of a campaign (e.g., an ad campaign, some other content-serving campaign). The query is decomposed into a first set of terms corresponding to attributes for which one or more predefined models exist, and a second set of terms for which no models exist. The predefined model for the first set of terms (or for a third term that is a superset of the first set of terms) is then used to estimate a number of future events that match the query terms.

### BACKGROUND

1. Field

The described embodiments relate to techniques for forecasting or estimating a number of electronic events of a particular type, wherein an event is defined by one or more criteria or attributes.

2. Related Art

Commercial entities and other organizations collect large quantities of data regarding various events regarding users of the electronic systems and services they provide. These events may in essence capture all or virtually all electronic activities of those users.

Therefore, these organizations may wish to obtain accurate forecasts of future activities of those users, to determine a likely number of impressions of a given advertisement that may be served, to predict times or targets of high traffic so as to perform better capacity planning and resource allocation, for focusing marketing efforts, and so on. However, the organizations may be unable to generate good forecasts because of a lack of pertinent base or historical data and/or for other reasons.

### BRIEF DESCRIPTION OF THE FIGURES

FIG. 1 is a block diagram illustrating a system that performs volume forecasting in accordance with an embodiment of the present disclosure.

FIG. 2 is a drawing illustrating a social graph in accordance with an embodiment of the present disclosure.

FIG. 3 is a flow chart illustrating a method for performing volume forecasting in accordance with an embodiment of the present disclosure.

FIG. 4 is a flow chart illustrating the method of FIG. 3 in accordance with an embodiment of the present disclosure.

FIG. 5 is a block diagram illustrating a computer system that performs the methods of FIGS. 3 and 4 in accordance with an embodiment of the present disclosure.

FIG. 6 is a block diagram illustrating a data structure for use in the computer system of FIG. 5 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of a system that includes a computer system, a technique for performing volume forecasting of “events”, and a computer-program product (e.g., software) for use with the computer system are described. Illustrative events for which volume forecasting may be performed may include the delivery of content items, specific activity of a user or member of an online service, intrusion attempts, login attempts, etc. In general, any electronic event that is related to a single application or online service, and that is therefore reflected in data captured and stored by the system that hosts the application or service, may be considered an event for which volume forecasting may be desired.

For example, a system for serving content (e.g., images, videos, songs, advertisements) may accumulate a pool of data regarding the content it serves (e.g., what was served, to whom, how, when, where). A social networking site may assemble a pool of data reflecting members' activities, their interactions with each other and/or the site, system events, attempted intrusions, etc. Events captured by these systems may reflect activity of those systems, system users, and/or third parties.

More specifically, events for which volume forecasting may be performed as described herein have associated timestamps (i.e., identifying when they occurred) and one or more attributes that reflect a type of event, an actor or actors that initiated or performed the event (e.g., a user, a system component), an object or objects affected by the event (e.g., a user profile, a content item), and/or other factors (e.g., a method of communication, a type of device involved in the event). The event attributes identified in a particular forecast query or request will vary not only from one query to another, but also from one host system or service to another. Illustrative attributes are identified further below.

Using past events and the attributes specified in a volume forecast query, an estimate can then be created regarding the number of future events (e.g., within some particular time period) that will occur and that will exhibit the specified attributes. For example, a forecast may be assembled to estimate how many profiles of users of an online service will be modified, and the forecast may be configured as coarsely or as finely as desired. Thus, one forecast may be requested regarding how many profiles of users in a particular state in the United States will be modified over the next week. Another forecast may be requested regarding how many profiles of users living within a particular city, having a specified gender, and being within a particular age group, will be modified within just the next 24 hours.

To aid forecasting and, in particular, to make it more responsive, some predefined models or predictions of future events may be generated in advance, or in anticipation of forecast queries. For example, if one or both of the preceding sample forecasts were requested on a regular basis, the system in which the forecasts are generated may generate corresponding predefined models. Thus, predefined models may be generated for the states for which forecasts are most commonly requested (e.g., California, New York, Texas) and/or for specific cities in those states (e.g., Los Angeles, San Francisco, New York City, Dallas, Houston), for multiple time periods, etc. These models may be computed online and/or offline.

At run-time—when a forecast query (i.e., a request for a volume forecast) is received—if a predefined model exists that exactly matches the query terms (i.e., the associated attributes), that model can be used directly to generate a responsive forecast of events. However, embodiments described herein are applied when no predefined model exactly matches the terms of the query, in which case a model for a similar or related term, or set of terms, is used to calculate a forecast.

In some particular embodiments implemented for a system in which advertising content (or some other type of content) is served, forecasts may be requested when individual content-serving campaigns are created, configured, or re-configured. The forecasts may be desired in order to estimate future numbers of distinct types of pertinent events, such as delivery of a specific content item (e.g., an ad impression) to a user having particular attributes, a user click on a content item of a certain type, a user viewing a content item served to him or her, a conversion (e.g., a user taking action offered by a content item), sharing or liking an item, and/or others. As described herein, the forecasts may be based on similar events that exhibited the same or similar attributes.

Thus, in the context of a content-serving campaign, events for which forecasts are requested may alternatively be considered opportunities for serving that content. Although embodiments are described below as implemented to provide volume forecasting of events or opportunities for serving advertising content, other embodiments associated with forecasts for other purposes (e.g., capacity planning, resource allocation) may be derived from the following discussion.

Further, embodiments are described below as implemented within a professional social networking service, site, or system, in which users (or members) initiate some or most events through their social networking activities. Other events may be initiated or performed by the service, components of the host system, non-users (e.g., spammers, potential intruders, advertisers), and/or other entities.

In some embodiments, the term “manager” is used to identify the person or entity that submits a volume forecast query or request. This term is intended to indicate that forecast queries may usually (but not always) be received from people other than users or members of the service or system in which the forecasts are developed. Illustratively, a manager may be a campaign manager (e.g., managing a particular ad campaign or other content-serving campaign), a product manager, a program manager, etc. In some implementations, however, users of the service or system may also (or instead) submit forecast queries.

As described previously, a forecast query will include one or more terms, with some or all of those terms matching attributes of previous events or of entities involved in previous events (e.g., actors, subjects, actions). In particular, a query's terms may be values for one or more known attributes, connected via disjunctions and/or conjunctions. Upon receipt, the query's terms are divided into two parts—a first set of one or more query terms that match (e.g., are values for) attributes for which predefined models are available (e.g., geographic area, age, device type, industry, content item identifier, title, gender), and a second set of zero or more terms for which no predefined models are available.

Thus, a predefined model does not necessarily exist for every exact term in the first set (and may not exist for any exact terms), but the terms are values for attributes for which predefined models exist. For example, a first term may be a specific age (e.g., 25). No predefined model may exist for that specific value, but models may exist for age ranges of 21-29, 15-30, etc.

After the query is decomposed into a first and second set of terms, a predefined model is accessed that estimates or forecasts the number of future events that match the first set of terms. Or, if no predefined model exists that exactly matches the first set of terms, a model is accessed that corresponds to a third term related to the first set of terms (or to a subset of the first set of terms).

Illustratively, this related third term may be a “superset” term that encompasses the first set of terms (or at least one or more terms in the first set of terms). A superset term is a term that is larger in scope than a first term. For example, if a first term identifies a relatively small geographical area (e.g., a town, a city), a related superset term may be a county, a state or a region. Similarly, for a first term that identifies a relatively narrow age range (e.g., “24-26”), a related superset term may be a larger age range (e.g., “21-29”). It is conceivable that a related term may instead be a subset of a first term (i.e., a term that is narrower in scope than the first term).

Thus, a predefined model is identified that corresponds either to the first set of terms or to a selected related term. This model includes or can be applied to obtain a forecast of future events that will match the corresponding term(s). If the model matches or corresponds exactly to the first set of terms, the model can simply be applied to obtain a forecast for the original query.

However, if the predefined model being used corresponds to a related term, instead of the entire first set of terms, a forecast provided by the model must be adjusted. To perform this adjustment, a first historical measure of events associated with the original query is retrieved, which includes or yields a count of previous events for the terms of the original query. A second historical measure (e.g., another count of events) is retrieved to obtain a count of previous events for queries having the related term. Illustratively, data may be retained over time for all events, or virtually all events.

A ratio is computed of past events corresponding to the original query to past events for the related term. This ratio is then multiplied by the forecast of the selected predefined model. This computation may be performed for one or more future time periods. Thus, the calculated ratio may be applied to events forecast by the predefined model for the next day, the next three days, the next week, the next month, etc.

Another way to describe operation of an embodiment is to consider an original query q comprising terms {t1, t2, t3, . . . }. A first set of terms Q1 for which predefined models exist may comprise {t1, t2}, while a second set of terms for which no predefined models exist may comprise {t3, . . . }. A predefined model for query Q1 (e.g., using a term T1 that is a superset of term t1 and/or of term t2), is then accessed to obtain a forecast F(Q1) of future events matching the query terms. If multiple superset terms related to t1 (and/or t2) are available, the one chosen (T1) may be the one that is closest in scope. Historical counts of content-delivery events are retrieved for original query q and for query Q1 and may be represented as c(q) and c(Q1), respectively. Finally, a forecast F(q) for query Q is calculated as:

$$F ( q ) = F ( Q 1 ) \times \frac{c ( q )}{c ( Q 1 )} .$$

In some situations it may be necessary to define multiple sub-queries for an original query's first set of terms, such as Q1={t1} and Q2={t2} for the example above; the second set of terms would then comprise {t3, . . . }. In these situations, the forecast for original query q would be

$$F ( q ) = {\sum }_{i = 1}^{n} F ( Q 1 ) \times \frac{c ( q )}{c ( Q i )} .$$

In this way, estimates may be obtained even for terms in advertising forecast query that have not been previously modeled.

By forecasting the volume of future events matching particular attributes, content-serving campaigns such as ad campaigns can be planned more effectively. In particular, by providing more accurate estimates of the volume of particular events that an advertiser wants to target (e.g., serving of ad impressions to users having specific attributes), the volume-forecasting technique may allow the campaign to be adjusted to reach the desired audience without exceeding an associated budget. Thus, the volume-forecasting technique may reduce the cost associated with an advertising campaign, and may reduce the opportunity cost associated with sub-optimal or unsuccessful advertising campaigns. Consequently, the volume-forecasting technique may increase the satisfaction of advertisers. Other content-serving campaigns, in which a manager or content provider wants to have particular content items served in association with particular events, can similarly benefit.

In the discussion that follows, a user may be a person that uses or operates a particular application or service (for example, a member, an existing customer, a new customer, a prospective employer, a prospective employee, a supplier, a service provider, a vendor, a contractor, etc.). The volume-forecasting technique may be used by an individual manager, an organization, a business, and/or a government agency. Furthermore, a ‘business’ should be understood to include for-profit corporations, non-profit corporations, groups (or cohorts) of individuals, sole proprietorships, government agencies, partnerships, etc.

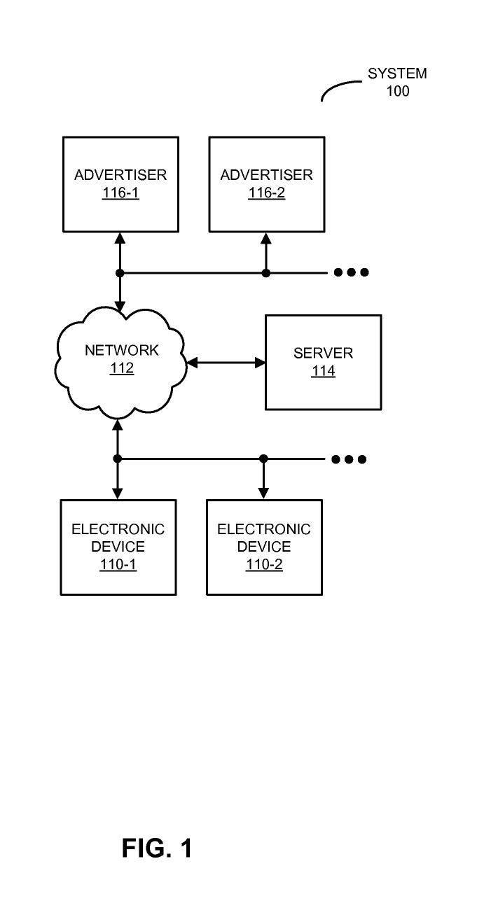

We now describe embodiments of the system and its use. FIG. 1 presents a block diagram illustrating a system 100 that performs event volume-forecasting. In this system, users of electronic devices 110 may use a software product, such as instances of a software application that is resident on and that executes on electronic devices 110.

In some implementations, the users may interact with a web page that is provided by server 114 via network 112, and which is rendered by web browsers on electronic devices 110. For example, at least a portion of the software application executing on electronic devices 110 may be an application tool that is embedded in the web page, and which executes in a virtual environment of the web browsers. Thus, the application tool may be provided to the users via a client-server architecture.

The software application operated by the users may be a standalone application or a portion of another application that is resident on and which executes on electronic devices 110 (such as a software application that is provided by server 114 or that is installed and which executes on electronic devices 110).

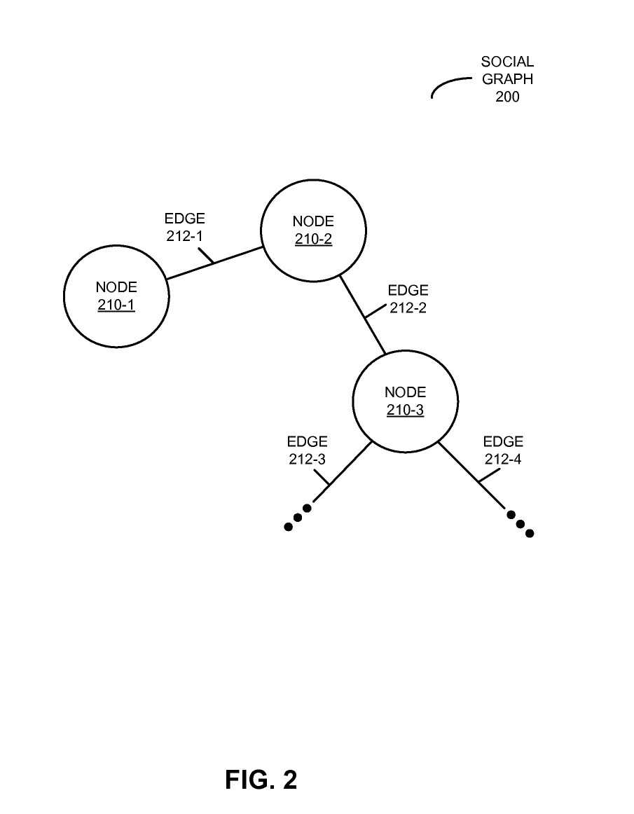

Using one of electronic devices 110 (such as electronic device 110-1) as an illustrative example, a user of electronic device 110-1 may use the software application to interact with other users in a social network, such as a professional social network, that facilitates interactions among the users. As described further below with reference to FIG. 2, the interactions among the users may specify a social graph in which nodes correspond to the users and edges between the nodes correspond to the users' interactions or relationships. Note that each of the users of the software application may have an associated profile that includes personal and professional characteristics and experiences (such as education, employment history, demographic information, work locations, etc.), which are collectively referred to as ‘attributes’ in the discussion that follows.

While the users of electronic devices 110 are using the software application, server 114 may provide content to one or more of electronic devices 110 via network 112. For example, the content may include one or more advertisements that are displayed on electronic devices 110 (such as in a web page by a browser) for the users to view. These advertisements may be presented to the users in the context of advertising campaigns conducted by advertisers 116. As described further below, advertisers 116 may interact with server 114 via network 112 to set or predefine the details of their advertising campaigns (such as targeting criteria for one or more targeted groups, budgets, etc.), and server 114 may provide the advertisements based on these predefined details.

In the discussion that follows, ‘advertisements’ should be understood to encompass content that promotes awareness and/or sales of a product or a service. However, in some embodiments, ‘advertisements’ encompass content related to employment. For example, an advertisement may alert users to an employment opportunity. Thus, advertisers 116 may also include potential employers. Note that the advertisements presented to the users by server 114 are sometimes referred to as ‘recommendations.’ Also, the term ‘advertisement’ as used herein may refer to a discrete advertising impression within a given campaign.

In response to the advertisements served to them, the users of electronic devices 110 may provide feedback in the form of actions taken on advertising impressions (or views), such as clicks and/or conversions. An ‘event as used herein may therefore include any or all of the serving of advertising impressions, viewing of advertising impressions by users, clicking on advertising impressions, conversion of advertising impressions, and/or other activity.

Server 114 may aggregate this information for multiple users, and may store this information for subsequent use. In addition, via network 112, server 114 may monitor and store information about events involving specific user actions or behaviors, such as: web pages or Internet Protocol (IP) addresses the users visit, search topics, search frequency, how often a given user checks who viewed their profile in the social network, how often the given user views profiles of other users in the social network, profile edits, page views, additions to an address book or list of contacts, etc.

Alternatively or additionally, while the users of electronic devices 110 are using the software application, the users may share with each other categorical content corresponding to predefined interest segments. For example, via network 112, the user of electronic device 110-1 may communicate that he or she ‘likes’ information about a topic (which, equivalently, is sometimes referred to as a ‘channel,’ a ‘category,’ an ‘interest category’ or an ‘interest segment’) with one of the other users. These ‘likes’ or ‘shares’ may be monitored by server 114 via network 112, and server 114 may aggregate and store these events for subsequent use. Note that the predefined interest segments may be defined or specified by one or more of the users in their profiles and/or may be specified by advertisers 116 in the predefined details or targeting criteria for their advertising campaigns.

When an event is stored, it may be stored with associated information such as a timestamp, an identity of the associated content item, one or more attributes or profile dimensions of a user involved in the event (e.g., identity, gender, location), etc.

Server 114 may use the stored information about advertising campaigns (e.g., attributes of target users and/or events) and events to train machine-learning models (which may be supervised or unsupervised) that can be used to predict future events. The models may use linear or statistical modeling.

In some embodiments, models are pre-computed or predefined for selected event attributes. These selected attributes may correspond to different types of events (e.g., serving of ad impressions, page views, profile edits, intrusion attempts), users or other actors involved in the events (e.g., geographic location, functional area, position, title, gender), objects involved in the events (e.g., user profiles, content items, job listings). For each such attribute, past (i.e., stored) content-delivery events may be divided among multiple time windows (e.g., fifteen minutes, one hour, eight hours, one day, one week, one month). This allows quick retrieval of historical counts of events matching one or more particular user dimensions. In addition, and as discussed immediately above, the predefined models provide fast access to pre-computed forecasts for the popular dimensions.

By monitoring, aggregating, and storing information about user-related events (e.g., their interactions with advertisements, their recommendations and their interactions with each other in the social network), server 114 may allow the users and their interests to be better targeted in advertising campaigns and/or other content-serving campaigns. This capability may allow server 114 to subsequently offer improved service to the users and advertisers 116, in the form of more effective advertisements, recommendations and/or interesting content. Consequently, a volume-forecasting technique implemented in system 100 may increase the satisfaction both of users and advertisers 116, and may increase the revenue and profitability of a provider of the software application.

Note that information in system 100 may be stored at one or more locations in system 100 (i.e., locally or remotely relative to server 114). Moreover, because this data may be sensitive in nature, it may be encrypted. For example, stored data and/or data communicated via network 112 may be encrypted.

We now further describe the profiles of the users. As noted previously, the profile of a user may, at least in part, specify a social graph or a portion of a social graph. FIG. 2 presents a drawing illustrating a social graph 200. This social graph may represent the connections or interrelationships among nodes 210 (corresponding to entities) using edges 212. In the context of a volume-forecasting technique, one of nodes 210 (such as node 210-1) may correspond to a user, and the remainder of nodes 210 may correspond to other users (or groups of users) in the social network. Therefore, edges 212 may represent interrelationships among these users, such as companies where they worked, schools they attended, organizations (companies, schools, etc.) that the individuals are (or used to be) associated with, etc.

In general, a given node in social graph 200 may be associated with a wide variety of information that is included in user profiles, including attributes such as: age, gender, geographic location, work industry for a current employer, functional area (e.g., engineering, sales, consulting), seniority in an organization, employer size, schools attended, previous employers, current employer, professional development, interest segments, target groups, additional professional attributes and/or inferred attributes (which may include or be based on user behaviors). Furthermore, user behaviors may include log-in frequencies, search frequencies, search topics, browsing certain web pages, locations (such as IP addresses) associated with the users, advertising or recommendations presented to the users, user responses to the advertising or recommendations, likes or shares exchanged by the users, and/or interest segments for the likes or shares. More generally, the user profiles may include inclusion and/or exclusion criteria for one or more advertising campaigns and that help match advertising campaigns to targeted users.

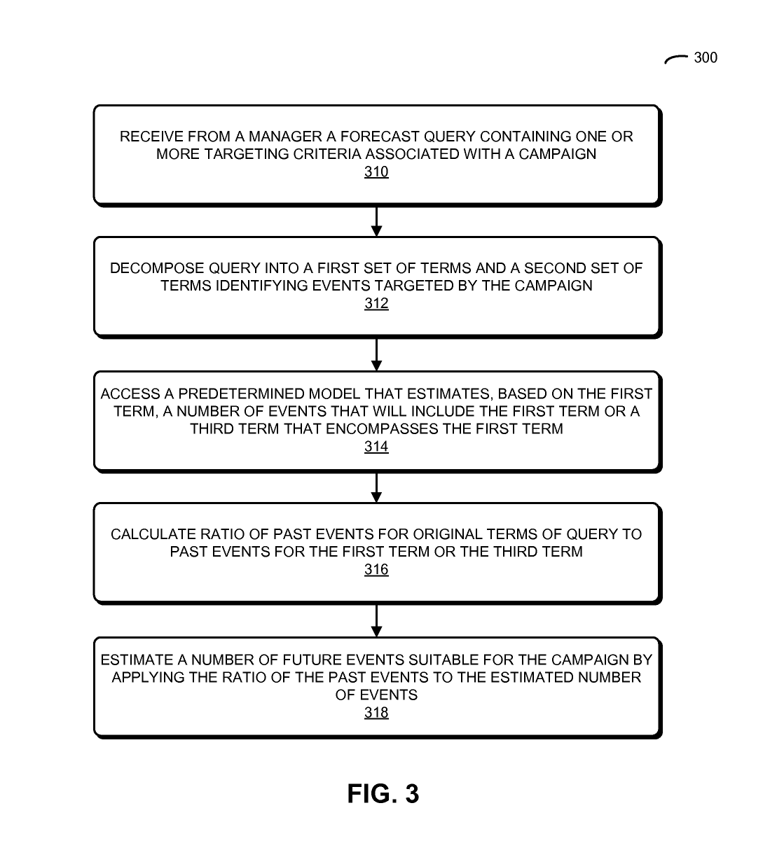

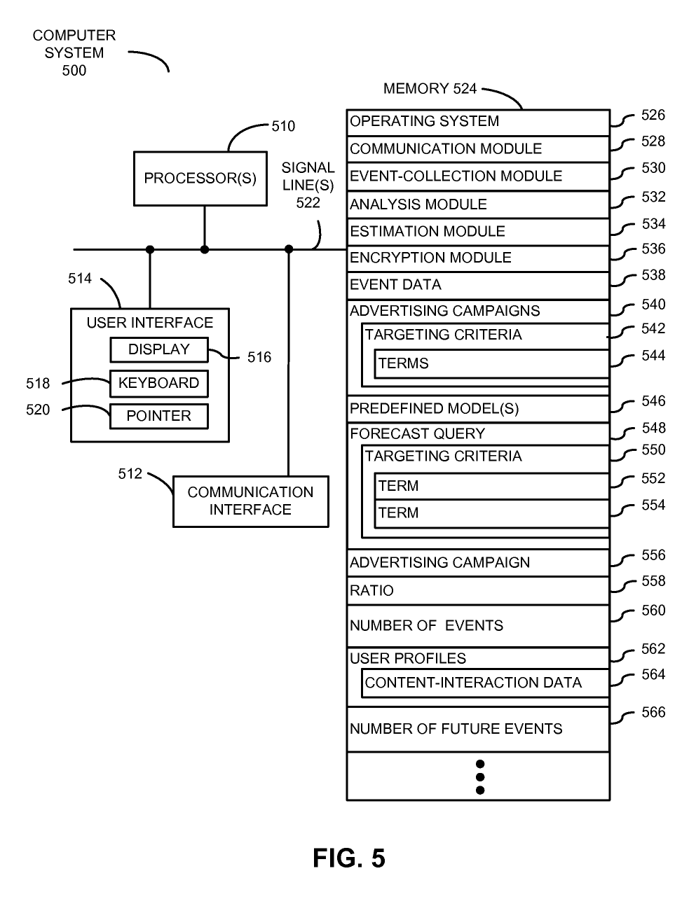

We now describe embodiments of the event volume-forecasting technique. FIG. 3 presents a flow chart illustrating a method 300 for performing volume forecasting, which may be performed by a computer system (such as server 114 in FIG. 1 or computer system 500 in FIG. 5). Although specific to a content-serving campaign (e.g., an ad campaign), the illustrated method may be readily adapted for other purposes.

During operation, the computer system receives from a manager a forecast query containing one or more targeting criteria associated with at least one advertising campaign (operation 310). For example, the one or more targeting criteria may include ‘San Francisco Bay area’ and ‘finance’, which may indicate that the forecast query related to an advertising campaign that targets individuals living in the specified geographical region and working in the specified field or functional area.

The computer system then decomposes the query's criteria into a first set having one or more terms that correspond to attributes for which at least one predefined model exists—such as “San Francisco Bay area,” which belongs to a “geographic area” attribute—and a second set having zero or more terms that correspond to attributes for which no predefined models exist—such as “finance,” which belongs to an “industry” attribute (operation 312). Thus, references to “first term” and “second term” as used herein may be understood to refer to a first set of terms and a second set of terms, respectively.

It may be noted that any number of terms may be received with an advertising query (e.g., more than two), and that any of those terms may be considered a ‘first term’ (or first set of terms) and a ‘second term’ (or second set of terms) for purposes of applying a process described herein

Then, the computer system accesses a predefined model (such as a supervised-learning model, an unsupervised-learning model or, more generally, a machine-learning model) that estimates a number of content-delivery events that include the first term or a third term than encompasses the first term (operation 314). In this way, if a predefined model for the first term exists, it may be used to estimate the number of future events that will exhibit the first term.

However, if a predefined model does not exist for the first term, a predefined model for a third term that encompasses the first term may be used. For example, if there is no predefined model for the ‘San Francisco Bay area’ term, a predefined model for ‘The United States’ (which encompasses, includes or is a superset of the San Francisco Bay area) may be used. The difference in historical events for the first term and the third term will be applied to scale-down a forecast based on the encompassing third term.

Alternatively, if the advertising query included the term ‘Southern California’ and there was no predefined model for this term, but there was a predefined model for ‘Los Angeles’ (which is a subset of Southern California), this predefined model may be used. As these examples illustrate, the third term may be related to the first term in a logical or hierarchical fashion.

In some embodiments implemented for advertising campaigns, events include advertising impressions and actions by recipients of the content-delivery events, such as viewing, clicking on and/or converting an advertising impression. Additionally, advertising impressions may be based on how often the users log in to the social network, if the advertising impressions are presented to the users whenever they log in.

The computer system now determines a ratio (operation 316) between past events that match the original terms of the advertising query and past events that match the first term or the third term (i.e., whichever corresponds to the predefined model accessed in operation 314). This ratio will apply the necessary scaling of the advertising query's historical performance.

Finally, the computer system estimates a future number of events targeted by the advertising campaign (operation 318) by multiplying the estimated number of events determined in operation 314 by the ratio computed in operation 316. For example, if the ratio was 200:300 (in millions of events), or 2:3, the forecast obtained in operation 314 would be multiplied by % to obtain the final forecast for the query.

In this way, a volume-forecasting technique described herein can perform event volume forecasting (e.g., estimate the audience size) for the events even when a predefined model for the combination of the first term and the second term does not exist. This may be useful, because generating predefined models for all the combinations of terms that identify target events for advertising campaigns may be prohibitive in terms of time, expense, and storage. Instead, a set of predefined models may be generated for a subset of the terms based on factors such as: a frequency of the terms (e.g., the first term) in forecast queries preceding the present query (i.e., at an earlier time); and/or an accuracy of the estimated number of events. For example, the predefined model may be included in the set of predefined models because the frequency of the first term in the advertising queries is at least 10% and/or the volume-forecasting error for the predefined model may be less than 10%.

In some embodiments of method 300, there may be additional or fewer operations. Moreover, the order of the operations may be changed, and/or two or more operations may be combined into a single operation.

Note that method 300 may be offered by a third party (e.g., another organization) as a paid service to an advertiser (e.g., a company or organization) that is planning a future campaign. Therefore, the operations in method 300 may be performed by the other organization. However, in other embodiments representatives of the advertiser perform at least some of the operations in method 300.

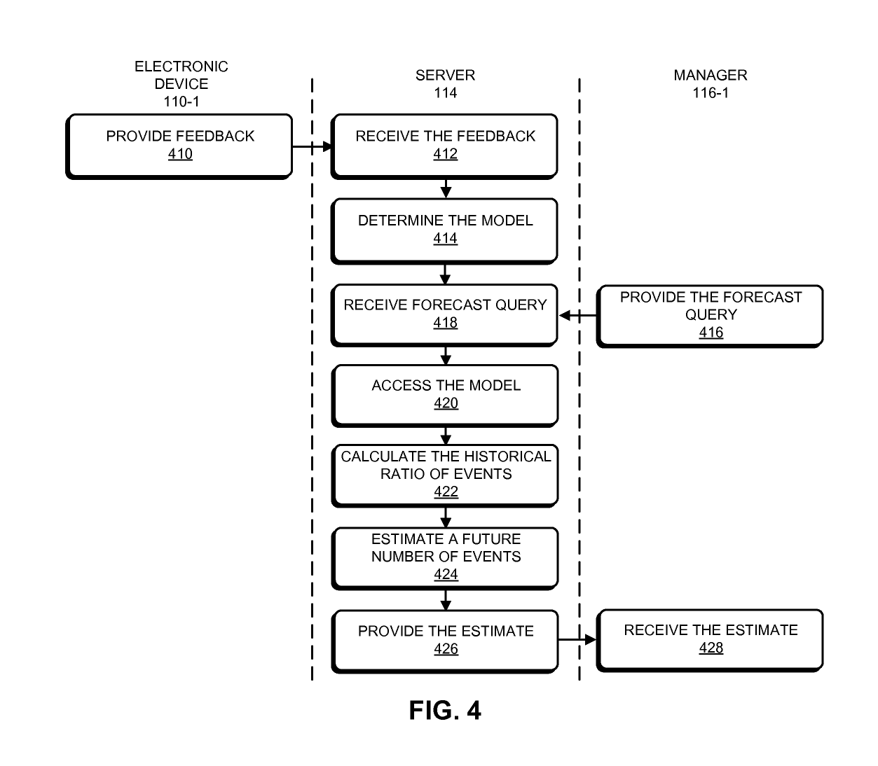

In an exemplary embodiment, the volume-forecasting technique is implemented using one or more electronic devices and at least one server, which communicate through a network, such as a cellular-telephone network and/or the Internet (e.g., using a client-server architecture). This is illustrated in FIG. 4, which presents a flow chart illustrating method 300 (FIG. 3).

During this method, users of electronic devices 110 in FIG. 1 (such as a user of electronic device 110-1 in operation 410) may provide feedback in response to advertising campaigns that targeted the users (i.e., the user may be in a target group for an advertising campaign, as specified by one or more targeting criteria). For example, the feedback may indicate an advertising-impression rate (or a number of advertising impressions), a click-through rate (or a number of clicks), a conversion rate (or a number of conversions), or some other rate of events. Server 114 may receive the feedback (operation 412). Then, server 114 may determine the model (operation 414) that estimates a number of content-delivery events for one or more terms in the one or more targeting criteria.

Subsequently, manager 116-1 (e.g., a campaign manager) may provide (operation 416) and server 114 may receive the forecast query (operation 418) containing the one or more targeting criteria for a future advertising campaign. The one or more targeting criteria include the first term and a second term.

In response, server 114 may access the (predefined) model (operation 420) that estimates the number of events that correspond to the first term or a third term encompassing the first term. Note that accessing the model may include calculating the number of events forecast by the model.

Moreover, server 114 may calculate the ratio (operation 422) between past events that match the advertising query (e.g., all terms) and past events that match the first term or second term (depending on which term's model is accessed).

Furthermore, server 114 may estimate the number of future events (operation 424) for the -delivery events.

Additionally, server 114 may provide (operation 426) and manager 116-1 may receive the estimate (operation 428). Advertiser 116-1 may use the estimate (and related information) to plan the future advertising campaign.

In an exemplary embodiment, a volume-forecasting technique is used to assist advertisers or other content providers. In particular, advertisers want to target audiences who would be more likely to respond to their advertisements. Often, the targeted audience or events (specified by the one or more targeting criteria) are identified using demographic and/or geographic attributes that are determined based on marketing intuition. The advertiser may want to forecast the number of advertising impressions that will be served or the size of traffic in real time based on the targeted audience and/or by end user segments. Because there may be a large number of combinations of the terms in the targeting criteria, it may be difficult to model all of the combinations for use in estimating the number of events.

This problem may be addressed using a combination of offline and online (e.g., real-time) analysis. Broad segments (based on particular terms or attributes, such as geographic location) may be selected and may be used to train models. For example, terms in advertising queries that have a frequency greater than 10% and/or that result in predefined models with an accuracy of better than 30% (over time) may be included in the set of predefined models. For example, there may be 5000 predefined models for different terms in the advertising queries.

In an exemplary embodiment, four weeks of historical advertising data may be used to train a model, and two weeks of historical advertising data may be used to cross-validate the model. As an example of events relevant to an advertising campaign, the total number of advertising impressions served per week may be on the order of 10 million.

These predefined models may be used, in part, to estimate the number of future events based on terms of a current query. As noted previously, if either or neither of the terms in the forecast query were previously modeled, a predefined model for a term that is a subset or a superset of the either of the terms in the advertising query may be used in the volume-forecasting technique.

We now describe embodiments of the computer system and its use. FIG. 5 presents a block diagram illustrating a computer system 500 that performs method 300 (FIG. 3). Computer system 500 includes one or more processing units or processors 510, a communication interface 512, a user interface 514, and one or more signal lines 522 coupling these components together. Note that the one or more processors 510 may support parallel processing and/or multi-threaded operation, the communication interface 512 may have a persistent communication connection, and the one or more signal lines 522 may constitute a communication bus. Moreover, the user interface 514 may include: a display 516 (such as a touch-screen), a keyboard 518, and/or a pointer 520 (such as a mouse).

Memory 524 in computer system 500 may include volatile memory and/or non-volatile memory. More specifically, memory 524 may include: ROM, RAM, EPROM, EEPROM, flash memory, one or more smart cards, one or more magnetic disc storage devices, and/or one or more optical storage devices. Memory 524 may store an operating system 526 that includes procedures (or a set of instructions) for handling various basic system services for performing hardware-dependent tasks. Memory 524 may also store procedures (or a set of instructions) in a communication module 528. These communication procedures may be used for communicating with one or more computers and/or servers, including computers and/or servers that are remotely located with respect to computer system 500.

Memory 524 may also include multiple program modules (or sets of instructions), including: event-collection module 530 (or a set of instructions), analysis module 532 (or a set of instructions), estimation module 534 (or a set of instructions), and/or encryption module 536 (or a set of instructions). Note that one or more of these program modules (or sets of instructions) may constitute a computer-program mechanism.

During operation of computer system 500, event-collection 530 may receive event data 538 regarding events captured by system 500, via communication interface 512 and communication module 528, and may store event data 538 in memory 524.

For example, event data regarding an ad campaign may indicate an advertisement-impression rate (or a number of advertising impressions), a click-through rate (or a number of clicks), and/or a conversion rate (or a number of conversions), and advertising campaigns 540 may include one or more targeting criteria 542. Other event data may identify numbers, types, and attributes of other events (e.g., page views, comments on a content item, profile edits, login attempts). In addition, historical counts of events are maintained.

Then, analysis module 532 may determine one or more predefined model(s) 546 based on event data 538 and the one or more targeting criteria. For example, analysis module 532 may use training and testing subsets of this information to generate one or more machine-learning models. The one or more predefined model(s) 546 may allow estimates of the number of future events to be determined for terms 544 in the one or more targeting criteria 542.

Subsequently, event-collection module 530 may receive, via communication interface 512 and communication module 528, forecast query 548 containing one or more targeting criteria 550 for an advertising campaign 556. For example, forecast query 548 may be received from a prospective advertiser wishing to know how many events may occur that may cause its advertisement to be served.

The one or more targeting criteria 550 may include first term (or first set of terms) 552 and second term (or second set of terms) 554. Note that there may be a predefined model in the one or more predefined model(s) 546 for term(s) 552, but not for term(s) 554. Alternatively or additionally, a predefined model in the one or more predefined model(s) 546 may exist for a term that encompasses term 552 (but which does not encompass term 554) or is a subset of term 552.

Estimation module 534 may use the predefined model in the one or more predefined model(s) 546 for term 552 to estimate, based on term 552, a future number of events 560 that include term 552, a term that encompasses term 552 or a term that is a subset of term 554.

Moreover, estimation module 534 may calculate ratio 558 between historical (past) events that match the full targeting criteria of query 548 and historical events that match term 552 or the term that encompasses term 552.

Furthermore, estimation module 534 may estimate a number of future events 566 in advertising campaign 556 by applying ratio 558 to number of events 560.

Additionally, event-collection module 530 may provide, via communication module 528 and communication interface 512, information about the number of future events 566 to the prospective advertiser, who may use this information to plan advertising campaign 556.

Note that user profiles 562 may include content-interaction data 564 that specifies interactions of users of a social network with categorical content corresponding to predefined interest segments. Moreover, content-interaction data 564 may include a number of views of the categorical content and a number of shares of the categorical content with other users of the social network.

In general, user profiles 562 may include attributes of the users and/or behaviors of the users when using the social network. Moreover, user profiles 562 may include information specified directly by the users and/or information inferred (i.e., gathered indirectly) about the users (which are sometimes referred to as ‘inferred attributes’).

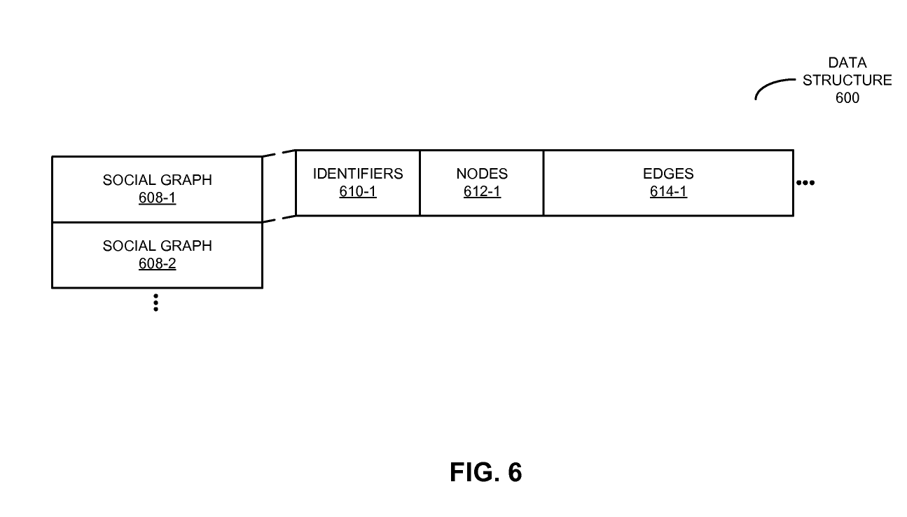

As noted previously, user profiles 562 may be included in a social graph that specifies the interactions and/or relationships among the users. This is shown in FIG. 6, which presents a block diagram illustrating a data structure 600 with one or more social graphs 608 for use in computer system 500 (FIG. 5). In particular, social graph 608-1 includes identifiers 610-1 for the users, nodes 612-1 (for associated attributes), and edges 614-1 that represent relationships or connections between nodes 612-1. For example, nodes 612-1 may include skills, jobs, companies, schools, locations, etc. Thus, nodes 612-1 may indicate interrelationships among the users in the social network, as indicated by edges 614-1. Therefore, one or more of social graphs 608 may be used to identify subsets of the users.

Referring back to FIG. 5, because information in computer system 500 may be sensitive in nature, in some embodiments at least some of the data stored in memory 524 and/or at least some of the data communicated using communication module 528 is encrypted using encryption module 536.

Instructions in the various modules in memory 524 may be implemented in a high-level procedural language, an object-oriented programming language, and/or in an assembly or machine language. Note that the programming language may be compiled or interpreted, e.g., configurable or configured, to be executed by the one or more processors.

Although computer system 500 is illustrated as having a number of discrete items, FIG. 5 is intended to be a functional description of the various features that may be present in computer system 500 rather than a structural schematic of the embodiments described herein. In practice, and as recognized by those of ordinary skill in the art, the functions of computer system 500 may be distributed over a large number of servers or computers, with various groups of the servers or computers performing particular subsets of the functions. In some embodiments, some or all of the functionality of computer system 500 is implemented in one or more application-specific integrated circuits (ASICs) and/or one or more digital signal processors (DSPs).

Computer systems (such as computer system 500), as well as computers and servers in system 100 (FIG. 1), may include one of a variety of devices capable of manipulating computer-readable data or communicating such data between two or more computing systems over a network, including: a personal computer, a laptop computer, a tablet computer, a mainframe computer, a portable electronic device (such as a cellular phone or PDA), a server and/or a client computer (in a client-server architecture). Moreover, network 112 (FIG. 1) may include: the Internet, World Wide Web (WWW), an intranet, a cellular-telephone network, LAN, WAN, MAN, or a combination of networks, or other technology enabling communication between computing systems.

System 100 (FIG. 1), computer system 500 and/or data structure 600 (FIG. 6) may include fewer components or additional components. Moreover, two or more components may be combined into a single component, and/or a position of one or more components may be changed. In some embodiments, the functionality of system 100 (FIG. 1) and/or computer system 500 may be implemented more in hardware and less in software, or less in hardware and more in software, as is known in the art.

While advertising has been used as an illustration in the preceding embodiments, the content in the content-delivery events may be other than advertising. For example, the content may include recommendations for potential employment opportunities or types of employment, recommendations regarding organizations or individuals that a user may wish to ‘follow,’ and/or other content that a user may be interested in.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer-system-implemented method for performing volume forecasting, the method comprising:
receiving a forecast query containing a first term and a second term that specify targeting criteria associated with a campaign;
accessing one of:
a first predefined model that estimates a number of events that match the first term, if the first predefined model exists; and
a third predefined model that estimates a number of events that match a third term that encompasses the first term, if the first predefined model does not exist;
using the computer, calculating a ratio between (a) past events matching the first term and the second term and (b) past events that match:
the first term, if the first predefined model is accessed; or
the third term, if the third predefined model is accessed; and
estimating a future number of events for the campaign by multiplying the estimated number of events by the calculated ratio.

2. The method of claim 1, wherein the events include serving an impression of an advertisement.

3. The method of claim 2, wherein the events further include:
receiving a click on the impression; and
receiving a conversion of the impression.

4. The method of claim 1, further comprising.
accessing a fourth predefined model that estimates a number of events that include a fourth term that is a logical subset of the first term, if the first predetermined model and the third predefined model do not exist.

5. The method of claim 1, wherein estimating the future number of events in the campaign is further based on inclusion criteria in the user profiles of users in the number of individuals.

6. The method of claim 1, wherein estimating the future number of events in the campaign is further based on exclusion criteria in the user profiles of users in the number of individuals.

7. The method of claim 1, wherein the first predefined model and the third predefined model were included in a set of predefined models based on a frequency of the first term in queries preceding the query.

8. The method of claim 1, wherein the first predefined model and the third predefined model were included in a set of predefined models based on an accuracy of previous estimated numbers of events.

9. The method of claim 1, wherein the third term includes the first term in a hierarchy.

10. A computer-program product for use in conjunction with a computer, the computer-program product comprising a non-transitory computer-readable storage medium and a computer-program mechanism embedded therein, to perform volume forecasting, the computer-program mechanism including:
instructions for receiving a forecast query containing a first term and a second term that specify targeting criteria associated with a campaign;
instructions for accessing one of:
a first predefined model that estimates a number of events that match the first term, if the first predefined model exists; and
a third predefined model that estimates a number of events that match a third term that encompasses the first term, if the first predefined model does not exist;
instructions for calculating a ratio between (a) past events matching the first term and the second term and (b) past content-delivery events that match:
the first term, if the first predefined model is accessed; or
the third term, if the third predefined model is accessed; and
instructions for estimating a future number of events for the campaign by multiplying the estimated number of events by the calculated ratio.

11. The computer-program product of claim 10, wherein the events include serving an impression of an advertisement.

12. The computer-program product of claim 11, wherein the events further include:
receiving a click on the impression; and
receiving a conversion of the impression.

13. The computer-program product of claim 10, further comprising:
accessing a fourth predefined model that estimates a number of events that include a fourth term that is a logical subset of the first term, if the first predetermined model and the third predefined model do not exist.

14. The computer-program product of claim 10, wherein estimating the future number of events in the campaign is further based on inclusion criteria in the user profiles of users in the number of individuals.

15. The computer-program product of claim 10, wherein estimating the future number of events in the campaign is further based on exclusion criteria in the user profiles of users in the number of individuals.

16. The computer-program product of claim 10, wherein the first predefined model and the third predefined model were included in a set of predefined models based on a frequency of the first term in queries preceding the query.

17. The computer-program product of claim 10, wherein the first predefined model and the third predefined model were included in a set of predefined models based on an accuracy of previous estimated numbers of events.

18. The computer-program product of claim 10, wherein the third term includes the first term in a hierarchy.

19. A computer, comprising:
a processor;
memory; and
a program module, wherein the program module is stored in the memory and configurable to be executed by the processor to perform volume forecasting, the program module including:
instructions for receiving a forecast query containing a first term and a second term that specify targeting criteria associated with a campaign;
instructions for accessing one of:
a first predefined model that estimates a number of events that match the first term, if the first predefined model exists; and
a third predefined model that estimates a number of events that match a third term that encompasses the first term, if the first predefined model does not exist;
instructions for calculating a ratio between (a) past events matching the first term and the second term and (b) past events that match:
the first term, if the first predefined model is accessed; or
the third term, if the third predefined model is accessed; and
instructions for estimating a future number of events for the campaign by multiplying the estimated number of events by the calculated ratio.

20. The computer system of claim 19, wherein the events include serving an impression of an advertisement.
